(19) United States
(12) Patent Application Publication
(10) Pub. No.: US 2011/0059712 A1
(43) Pub. Date: Mar. 10, 2011

(54) PORTABLE WIRELESS DEVICE

(75) Inventors: Haruhiko Kakitsu, Miyagi (JP); Hideki Hayama, Kanagawa (JP); Yukari Yamazaki, Miyagi (JP); Hiroyuki Uejima, Miyagi (JP)

(73) Assignee: PANASONIC CORPORATION, Osaka (JP)

(21) Appl. No.: 12/991,871

(22) PCT Filed: Feb. 20, 2009
(86) PCT No.: PCT/JP2009/000751

§ 371 Date: Nov. 9, 2010

(30) Foreign Application Priority Data
May 9, 2008 (JP) 2008-123155

(51) Int. Cl. H04B 7/00

(52) U.S. Cl. 455/253.2

(57) ABSTRACT

There is provided a portable radio that makes it possible to assure high receiving performance by improving deterioration of antenna gain attributable to electromagnetic field coupling between the plurality of antennas.

A portable radio has a first antenna 11; a second antenna 13; a first low noise amplifier 12 connected to the first antenna 11; a second low noise amplifier 14 connected to the second antenna 13; and a DTV tuner module 15 that can perform diversity combination and that is connected to the first low noise amplifier 12 and the second low noise amplifier 14, wherein an input impedance of the first low noise amplifier 12 and an input impedance of the second low noise amplifier 14 entirely differ from each other at an operating frequency band of the DTV tuner module 15 capable of performing diversity combination.

### TECHNICAL FIELD

The present invention relates to a portable radio and, more particularly, to a portable radio that is equipped with a plurality of antennas and a receiver, which is connected to the antennas and which enables performance of diversity operation, and that can assure high receiving performance by improving deterioration of an antenna gain resulting from electromagnetic field coupling of the plurality of antennas.

### BACKGROUND ART

FIG. 9(a) shows an example general configuration of a related art portable radio. The portable radio has a first antenna 11; a first amplifier 12 that amplifies a signal received by the first antenna 11; a second antenna 13 for performing diversity combination receiving; a second amplifier 14 for amplifying a signal received by the second antenna 13; and a DTV (Digital Television) tuner module 15 capable of performing diversity combination by means of an output from the first amplifier 12 and an output from the second amplifier 14.

The first amplifier 12 and the second amplifier 14 are set such that input impedance characteristics of operating bands of the amplifiers become equal to each other. FIG. 9(b) is a view for describing an input impedance of an amplifier 17. As illustrated, the input impedance of the amplifier 17 is equal to an impedance of an input terminal 16 of the amplifier 17 achieved when a 50-ohm resistor is placed between an output terminal of the amplifier 17 and a ground.

FIG. 10 is a Smith chart representing an input impedance of an amplifier acquired at a DTV operating band in the related art portable radio. FIG. 10(a) shows an input impedance characteristic 19 of the first amplifier 12, and FIG. 10(b) shows an input impedance characteristic 20 of the second amplifier 14. An input impedance of an amplifier is generally represented by Z=R+jX, and the input impedance of a radio is set to about 50-ohm. An input impedance of the amplifier achieved in a DTV operating band is represented within a circle enclosing a center (50-ohm) on the Smith chart.

FIG. 11 shows a general configuration 2 of a related art portable radio including packages. In the portable radio, the first amplifier 12 and the second amplifier 14, both of which are built from transistors made of silicon germanium or gallium arsenide, have impedances that greatly differ from 50-ohm. Commercially-available amplifiers are packaged with additional impedance matching sections 22 and 25, thereby providing 50-ohm matching.

Specifically, the second 50-ohm impedance matching section 22 is connected to an input stage of the first amplifier 12, and the first amplifier is then packaged. A fifth 50-ohm impedance matching section 25 is connected to an input stage of the second amplifier 14, and the second amplifier is then packaged. In this case, the packaged first amplifier 12 and the packaged second amplifier 14 are set such that their input impedance characteristics acquired at operating bands become equal to each other.

When the first antenna 11 and the second antenna 13 are pullout whip antennas, or the like, and when the antennas are applied to a foldable portable radio, a first 50-ohm impedance matching section 21 and a fourth 50-ohm impedance matching section 24 are provided in order to compensate for an impedance change incidental to opening and closing actions of enclosures. A third 50-ohm impedance matching section 23 and a sixth 50-ohm impedance matching section 26 are further interposed between the first amplifier 12, the second amplifier 14 and the DTV tuner module 15.

FIG. 12 is a drawing for describing an impedance of circuitry in the related art portable radio. As illustrated, since the related art portable radio has the first 50-ohm impedance matching section 21 to the sixth 50-ohm impedance matching section 26 placed in signal lines, an impedance acquired at the DTV operating band at respective points on the signal lines come to about 50 ohms.

Meanwhile, attention has been paid to an Orthogonal Frequency Division Multiplexing (OFDM) scheme characterized by multipath fading and high ghost resistance, as a modulation scheme appropriate for an application to mobile digital transmission, a terrestrial digital television broadcast, or a wireless LAN. A proposed OFDM modulated signal receiver includes amplifiers connected to respective antennas; detects a carrier-to-noise ratio; calculates a weighting coefficient commensurate with the detected carrier-to-noise ratio; and can perform diversity combination (see; for instance, Patent Document 1).

Patent Document 1: JP-A-2005-175878

### DISCLOSURE OF THE INVENTION

### Problem that the Invention is to Solve

However, the related art receiver has a potential fear of encountering deterioration of antenna performance, which would be caused by electromagnetic field coupling between the diversity combination antennas. In particular, applications operating at a frequency band that is lower than operating bands of a portable phone and a PHS; for instance, a digital television broadcast, undergo great influence.

The present invention has been conceived in light of the foregoing circumstance and aims at providing a portable radio that enables viewing of a highly sensitive application; for instance, a digital television broadcast, or the like, by improving deterioration of an antenna gain attributable to electromagnetic field coupling between the plurality of antennas.

### Means for Solving the Problem

A portable radio of the present invention includes: a first antenna; a second antenna; a first low noise amplifier electrically whose one end is electrically connected to the first antenna; a second low noise amplifier whose one end is electrically connected to the second antenna; and a receiving circuit electrically connected to a remaining end of the first low noise amplifier and a remaining end of the second low noise amplifier, wherein an input impedance of the first low noise amplifier and an input impedance of the second low noise amplifier entirely differ from each other in a predetermined operating frequency band of the receiving circuit.

In the above configuration, an input impedance of the first low noise amplifier and an input impedance of the second low noise amplifier entirely differ from each other in a predetermined operating frequency band of the receiving circuit, and no overlapping domain exists in a Smith chart. Therefore, an impedance of the first antenna in an input stage of the first low noise amplifier and an impedance of the second antenna in an input stage of the second low noise amplifier differ from each other; hence, electromagnetic field coupling between the first antenna and the second antenna is diminished, so that gain deterioration attributable to electromagnetic field coupling is improved. It is also possible to view a highly sensitive digital television broadcast by improving gain deterioration of the first antenna and gain deterioration of the second antenna.

A portable radio of the present invention includes: a first antenna; a first impedance matching section whose one end is electrically connected to the first antenna; a first low noise amplifier whose one end is electrically connected to a remaining end of the first impedance matching section; a second antenna; a complex conjugate matching section whose one end is electrically connected to the second antenna; a second low noise amplifier whose one end is electrically connected to a remaining end of the complex conjugate matching section; a second impedance matching section whose one end is electrically connected to a remaining end of the second low noise amplifier; and a receiving circuit electrically connected to a remaining end of the first low noise amplifier and a remaining end of the second impedance matching section, wherein the first impedance matching section matches the input impedance of the first low noise amplifier to a predetermined input impedance of the receiving circuit, and wherein the complex conjugate matching section matches an impedance of the second antenna and an impedance of an input stage of the second low noise amplifier to a complex conjugate impedance; and the second impedance matching section matches an output impedance of the second low noise amplifier to a predetermined input impedance of the receiving circuit.

In the configuration, the complex conjugate matching section matches an impedance of the second antenna and an impedance of an input stage of the second low noise amplifier to a complex conjugate impedance. Therefore, even when the impedance of the second antenna has greatly differed from the input impedance of the second low noise amplifier, it becomes possible for a matching circuit entailing a little loss to perform matching. Moreover, the impedance of the first antenna is acquired by matching the input impedance of the first low noise amplifier to the predetermined input impedance of the receiving circuit. On the contrary, the impedance of the second antenna and the impedance of the input stage of the second low noise amplifier are matched to the complex conjugate impedance. Therefore, the impedance of the first antenna of the input stage of the first low noise amplifier and the impedance acquired as a result of the second antenna of an input stage of the second low noise amplifier being connected to the complex conjugate matching section can be made differ from each other, so electromagnetic field coupling between the first antenna and the second antenna can be diminished. Therefore, it is possible to view a highly sensitive digital television broadcast.

The portable radio of the present invention further includes: a third impedance matching section whose one end is electrically connected to the first antenna and whose remaining end is electrically connected to one end of the first impedance matching section, wherein the third impedance matching section matches an output impedance of the first antenna to a predetermined input impedance of the receiving circuit.

In the configuration, the third impedance matching section matches the impedance of the first antenna to a predetermined input impedance of the receiving circuit. Accordingly, a received signal loss can further be reduced and supplied to the receiving circuit more effectively.

The portable radio of the present invention further includes a fourth impedance matching section whose one end is electrically connected to a remaining end of the first low noise amplifier and whose remaining end is electrically connected to the receiving circuit, wherein the fourth impedance matching section matches an output impedance of the first low noise amplifier to a predetermined input impedance of the receiving circuit.

In the configuration, the fourth impedance matching section matches an output impedance of the first low noise amplifier to a predetermined input impedance of the receiving circuit. Hence, it becomes possible to reduce an output loss of the first low noise amplifier, thereby more effectively supply the output to the receiving circuit.

The portable radio of the present invention further comprises a diversity circuit for subjecting a signal from the first antenna and a signal from the second antenna to diversity processing, wherein the diversity circuit is included in the receiving circuit or electrically connected to the receiving circuit.

In the configuration, it is possible to efficiently view a highly sensitive digital television broadcast from the signals received by the first antenna and the second antenna.

Further, in the portable radio of the present invention, the diversity circuit is a diversity circuit for performing diversity combination processing.

In the configuration, it is possible to efficiently view a highly sensitive digital television broadcast from the signals received by the first antenna and the second antenna.

In the portable radio of the present invention, the first impedance matching section and the first low noise amplifier are built into a single module.

In the configuration, the input impedance of the amplifier can be matched to a predetermined impedance by means of one module, so that designing and maintenance of the portable radio are facilitated.

In the portable radio of the present invention, the first antenna is a whip antenna projecting out of enclosures of the portable radio; and the second antenna is an antenna element built in the enclosures of the portable radio.

In the configuration, an impedance of the whip antenna serving as the first antenna is matched to a predetermined impedance, and the built-in antenna element serving as the second antenna is subjected to matching by means of a complex conjugate impedance. The second antenna can thereby be connected to the second low noise amplifier with a smaller loss. Further, the impedance of the first antenna is matched to a predetermined impedance, whereas the impedance of the second antenna is matched to the complex conjugate impedance. Thus, the impedance of the first antenna and the impedance of the second antenna can be made differ from each other, so that electromagnetic field coupling between the first antenna and the second antenna can be diminished. In this case, gain deterioration occurring between the antennas can be lessened, and a highly sensitive digital television broadcast can be viewed.

The portable radio of the present invention further includes a first circuit board placed in a first enclosure and a second circuit board placed in a second enclosure. The first antenna is a dipole antenna including at least a portion of the first circuit board and a portion of the second circuit board; and the second antenna is an antenna element built in the enclosures of the portable radio.

In the configuration, an impedance of the enclosure dipole antenna serving as the first antenna is matched to a predetermined impedance, and the built-in antenna element serving as the second antenna is subjected to matching by means of the complex conjugate impedance. The second antenna can thereby be connected to the second low noise amplifier with a smaller loss. Further, an impedance of the first antenna is matched to a predetermined impedance, whereas the impedance of the second antenna is matched to the complex conjugate impedance. Thus, the impedance of the first antenna and the impedance of the second antenna can be made differ from each other, so that electromagnetic field coupling between the first antenna and the second antenna can be diminished. In this case, gain deterioration occurring between the antennas can be lessened, and a highly sensitive digital television broadcast can be viewed.

### ADVANTAGE OF THE INVENTION

Deterioration of an antenna gain attributable to electromagnetic field coupling between a plurality of antennas is improved, whereby viewing of a highly sensitive digital television broadcast becomes possible.

### BRIEF DESCRIPTION OF THE DRAWINGS

FIG. 1 is a view showing a general configuration of a portable radio of a first embodiment of the present invention.

FIG. 2 is a Smith chart representing an input impedance of the amplifier achieved in a DTV operating band in the portable radio of the first embodiment of the present invention.

FIG. 3 is a view for describing an advantage of the portable radio of the embodiment of the present invention.

FIG. 4 is a view showing a general configuration of a portable radio of a second embodiment of the present invention.

FIG. 5 is a view for explaining an impedance difference of circuitry in the portable radio of the second embodiment of the present invention.

FIG. 6 is a Smith chart for explaining a difference between a 50-ohm impedance matching section and a complex conjugate matching section in the portable radio of the second embodiment of the present invention.

FIG. 7 is a view showing a general configuration of a portable radio of a third embodiment of the present invention of the present invention.

FIG. 8 is a view showing an impedance difference of circuitry in the portable radio of the third embodiment.

FIG. 9 is a view showing an example general configuration of a related art portable radio.

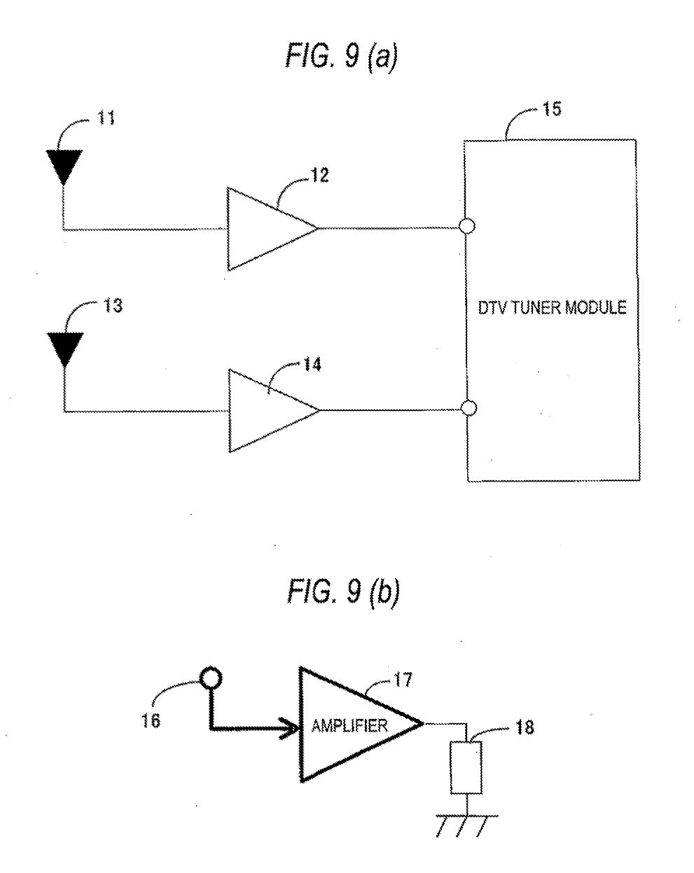

FIG. 10 is a Smith chart representing an input impedance of the amplifier achieved in a DTV operating band in the related art portable radio.

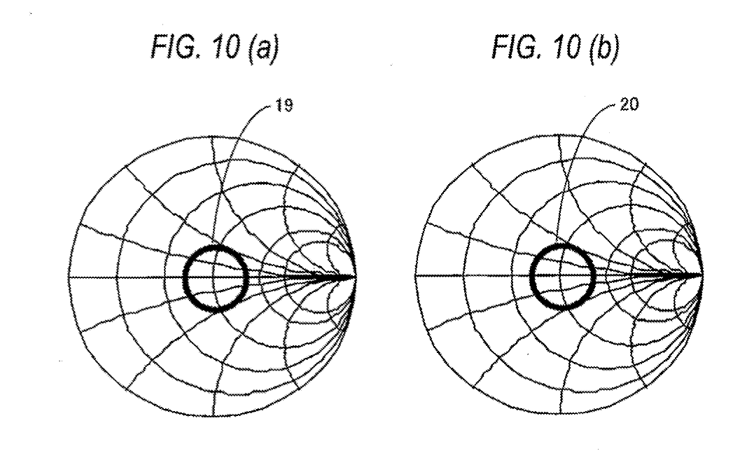

FIG. 11 is a view showing a general configuration of the related art portable radio including packages.

FIG. 12 is a drawing for describing an impedance of circuitry in the related art portable radio.

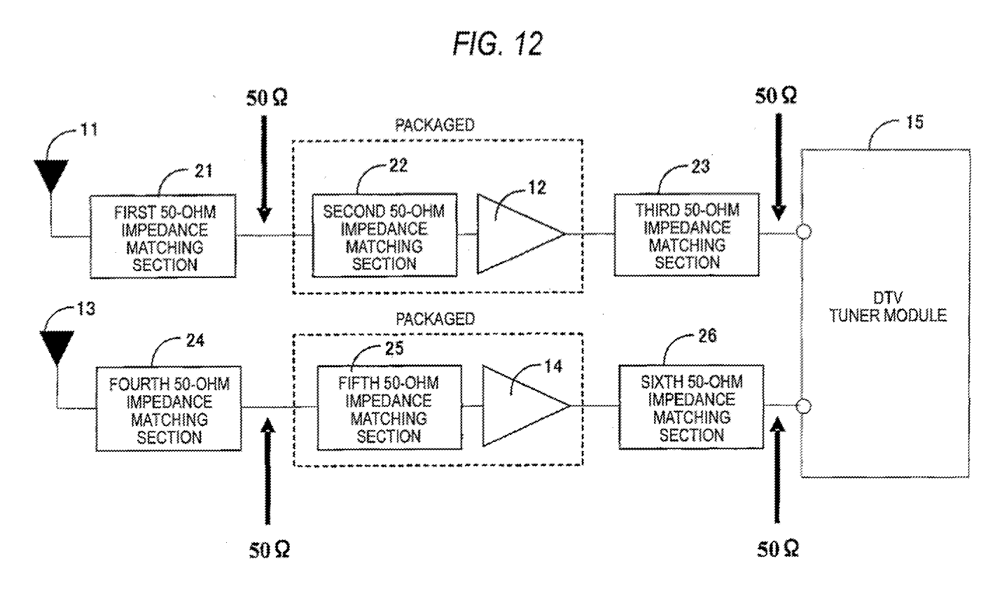

FIG. 13 is a view showing an example configuration of a portable radio having an enclosure dipole antenna and a built-in antenna element of the embodiment of the present invention.

### DESCRIPTIONS OF THE REFERENCE NUMERALS AND SYMBOLS

1 PORTABLE RADIO
11 FIRST ANTENNA
12 FIRST AMPLIFIER
13 SECOND ANTENNA
14 SECOND AMPLIFIER
15 DTV TUNER MODULE
21 FIRST 50-OHM IMPEDANCE MATCHING SECTION
22 SECOND 50-OHM IMPEDANCE MATCHING SECTION
23 THIRD 50-OHM IMPEDANCE MATCHING SECTION
24 FOURTH 50-OHM IMPEDANCE MATCHING SECTION
25 FIFTH 50-OHM IMPEDANCE MATCHING SECTION
26 SIXTH 50-OHM IMPEDANCE MATCHING SECTION
41 FIRST COMPLEX CONJUGATE MATCHING SECTION
102, 103 HINGE
104 LOWER ENCLOSURE
105 UPPER ENCLOSURE
106, 112 CIRCUIT BOARD
110, 111 ANTENNA ELEMENT
120 ANTENNA ELEMENT

### BEST MODES FOR IMPLEMENTING THE INVENTION

A portable radio of an embodiment of the present invention is a portable radio that is equipped with a television receiving feature having a diversity combination function and that has two antennas and two amplifiers inserted in two signal lines connecting the two antennas to a television tuner capable of performing diversity operation. Amplifiers exhibiting different input impedance characteristics at an operating band are used for the two amplifiers.

### First Embodiment

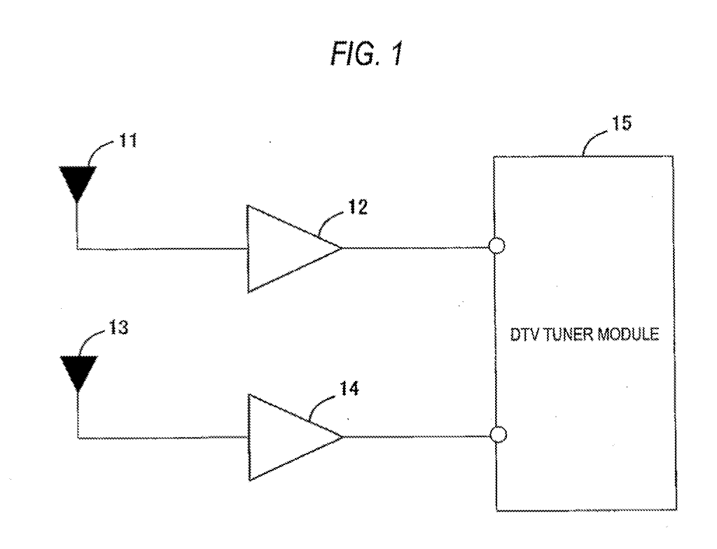

FIG. 1 shows a general configuration of a portable radio of a first embodiment of the present invention. The portable radio has a first antenna 11; a first amplifier 12 that amplifies a signal received by the first antenna 11; a second antenna 13; a second amplifier 14 that amplifiers a signal received by the second antenna 13; and a DTV tuner module 15 capable of performing diversity combination by means of an output from the first amplifier 12 and an output from the second amplifier 14. The first amplifier 12 and the second amplifier 14 are set so as to exhibit different input impedance characteristics at an operating band. The amplifiers 12 and 14 are; for instance, low noise amplifiers (LNA).

The DTV tuner module 15 has a receiving circuit that performs tuning processing for selecting a signal with a frequency band, which is employed in the DTV and which is included in the received signals from the first antenna 11 and the second antenna 13, and demodulation processing for demodulating the signal with the frequency band selected through tuning. A common receiving circuit can be provided for both the first antenna 11 and the second antenna 13, or an individual receiving circuit may also be provided separately for the first antenna 11 and the second antenna 13. The DTV tuner module can subject the signal from the first antenna 11 and the signal from the second antenna 13 to diversity processing, such as diversity combination or diversity selection. Diversity processing may be performed by the receiving circuit. Alternatively, when the receiving circuit is separately provided for each of the antennas, each of the diversity circuits electrically connected to the respective receiving circuits may also perform diversity processing.

Electrical connections in the portable radio of the embodiment shown in FIG. 1 are as follows; namely, the first antenna 11 is electrically connected to one end of the first amplifier 12. Further, the other end of the first amplifier 12 is electrically connected to the DTV tuner module 15. The second antenna 13 is electrically connected to one end of the second amplifier 14. The other end of the second amplifier 14 is electrically connected to the DTV tuner module 15. Specifically, the amplifiers 12 and 14 are electrically connected to a receiving circuit included in the DTV tuner module.

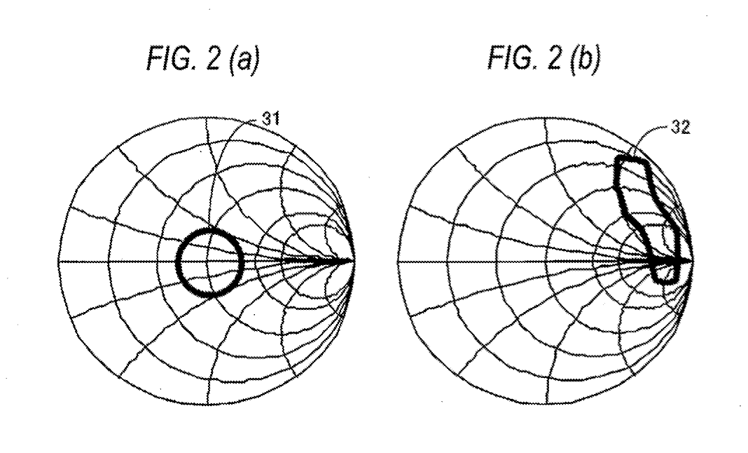

FIG. 2 shows a Smith chart representing an input impedance of the amplifier acquired at the DTV operating band in the portable radio of the present embodiment. FIG. 2(a) shows an impedance characteristic (input impedance) of an input stage of the first amplifier 12 (a stage connected to the first antenna 11). The chart shows that the impedance of the input stage of the first amplifier 12 acquired at the DTV operating band falls in a circle 31 in the drawing. FIG. 2(b) shows an impedance characteristic (input impedance) of an input stage of the second amplifier 14 (a stage connected to the second antenna 13). The chart shows that the impedance of the input stage of the second amplifier 14 acquired at the DTV operating band falls in a circle 32 in the drawing. As illustrated, in the portable radio of the present embodiment, the first amplifier 12 and the second amplifier 14 inserted in the two signal lines connecting the two antennas 11 and 13 to the DTV tuner module 15 differ from each other in terms of input impedance in a predetermined operating frequency band of the receiving circuit, and no overlap exists in the Smith charts. The expression “predetermined operating frequency band of the receiving circuit” means a frequency band of a DTV signal included in; for instance, a radio wave received by the antenna; in other words, an operating band of the DTV. Further, in order to lessen a loss which occurs when the first antenna 11 and the first amplifier 12 are connected together, it is preferable to have a match between impedance of the first antenna 11 and input impedance of the first amplifier 12. Likewise, it is also preferable to have a match between impedance of the second antenna 13 and input impedance of the second amplifier 14.

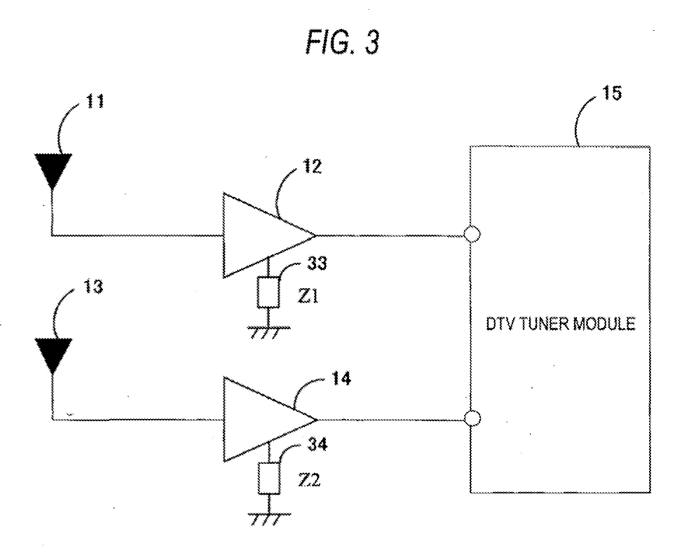

FIG. 3 is a view for describing an advantage of the portable radio of the embodiment of the present invention. The first amplifier 12 and the second amplifier 14 are formed by mounting transistors on a substrate. Hence, impedance Z1 (33) arises between the first amplifier 12 and a substrate ground, and impedance Z2 (34) arises between the second amplifier 14 and the substrate ground. When Z1=Z2 stands at a certain frequency, coupling between the first antenna 11 and the second antenna 13 increases. When Z1≠Z2 stands, the coupling between the first antenna 11 and the second antenna 13 decreases.

In the portable radio of the present embodiment, the two antennas 11 and 13 are connected to the respective amplifiers 12 and 14 exhibiting different characteristics (different impedance characteristics of the operating band). Therefore, the two antennas 11 and 13 also exhibit the different terminal impedances Z1 (33) and Z2 (34) at a certain frequency. Since the terminal impedances differ from each other, the electromagnetic field coupling between the antennas 11 and 13 decreases, whereby gain deterioration attributable to the electromagnetic field coupling is improved. Highly sensitive digital television broadcasts can be viewed by improving gain deterioration of the antennas 11 and 13.

As mentioned above, the portable radio of the present embodiment has the first antenna 11; the second antenna 13; the first low noise amplifier 12 connected to the first antenna 11; the second low noise amplifier 14 connected to the second antenna 13; and the DTV tuner module 15 that is connected to the first low noise amplifier 12 and the second low noise amplifier 14 and that can perform diversity combination. In the operating frequency band of the DTV tuner module 15 capable of performing diversity combination, the input impedance of the first low noise amplifier 12 and the input impedance of the second low noise amplifier 14 differ from each other.

Therefore, the terminal impedances of the two antennas 11 and 13 differ from each other in the operating frequency band, and the electromagnetic field coupling between the antennas 11 and 13 decreases. Gain deterioration attributable to electromagnetic field coupling is eventually improved. Highly sensitive digital television broadcasts can be viewed by improving gain deterioration of the antennas 11 and 13.

### Second Embodiment

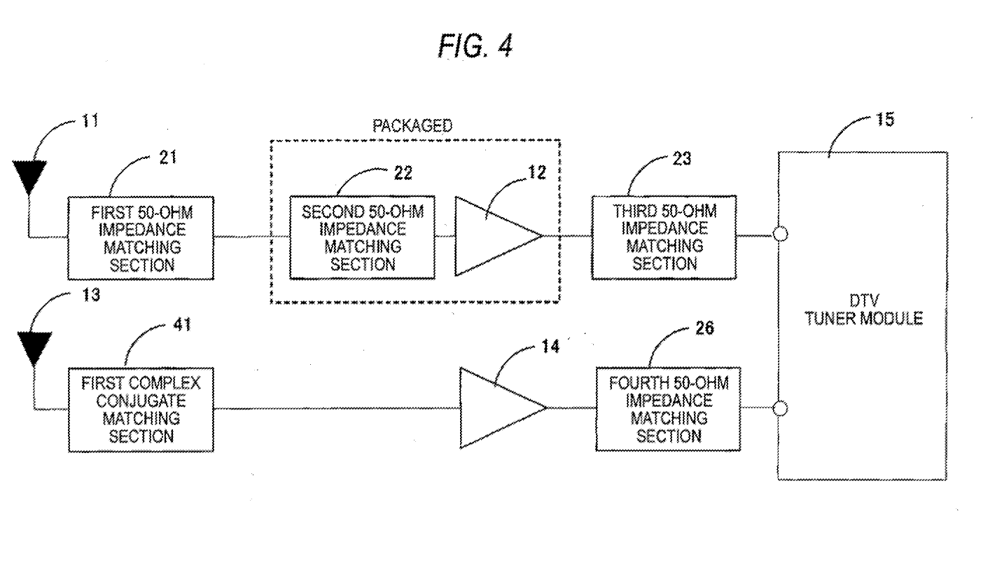

FIG. 4 shows a general configuration of a portable radio of a second embodiment of the present invention. In FIG. 4, constituent elements that are identical with their counterparts shown in FIG. 1 are assigned the same reference numerals, and their explanations are omitted. The portable radio shown in FIG. 4 has the first antenna 11; a first 50-ohm impedance matching section 21; a second 50-ohm impedance matching section 22; the first amplifier 12; a third 50-ohm impedance matching section 23; the second antenna 13; a complex conjugate matching section 41; the second amplifier 14; a fourth 50-ohm impedance matching section 26; and the DTV tuner module 15 that can perform diversity combination operation by means of an output from the third 50-ohm impedance matching section 23 and an output from the fourth 50-ohm impedance matching section 26. Each of the 50-ohm impedance matching sections matches an impedance to about 50-ohm at least one operating frequency of the DTV. A value of 50-ohm is a mere example impedance, and a matched impedance is not limited to 50-ohm and may be any value, so long as the value is equal to a predetermined input impedance of a receiving circuit belonging to the DTV tuner module.

The second 50-ohm impedance matching section 22 and the first amplifier 12 can be assembled into a single module; namely, packaged. The first amplifier 12 and the second amplifier 14 are made up of transistors, or the like, that are formed from silicon germanium or gallium arsenide. The impedance of these amplifiers sometimes vary from 50-ohm. As mentioned above, as a result of the impedance matching section and the amplifier being packaged into a module, the package becomes equivalent to an amplifier whose impedance is matched to 50-ohm.

The input impedance characteristic of the first amplifier 12 and the input impedance characteristic of the second amplifier 14 may be set so as to partially become equal to each other or entirely differ from each other at the operating band of the DTV. The input impedance characteristic of the second 50-ohm impedance matching section 22 that can be packaged and the input impedance characteristic of the first amplifier 12 (in other words, the input impedance characteristic of the second 50-ohm impedance matching section 22) and an input impedance characteristic of the second amplifier 14 are set so as to entirely differ from each other at the operating band of the DTV.

Electrical connections in the portable radio of the present embodiment shown in FIG. 4 are as follows: namely, the first antenna 11 is electrically connected to one end of the first 50-ohm impedance matching section 21. The other end of the first 50-ohm impedance matching section 21 is electrically connected to one end of the second 50-ohm impedance matching section 22. The other end of the second 50-ohm impedance matching section 22 is electrically connected to one end of the first amplifier 12. The other end of the first amplifier 12 is electrically connected to one end of the third 50-ohm impedance matching section 23. The other end of the third 50-ohm impedance matching section 23 is electrically connected to the DTV tuner module 15. The second antenna 13 is electrically connected to one end of the complex conjugate matching section 41. The other end of the complex conjugate matching section 41 is electrically connected to one end of the second amplifier 14. The other end of the second amplifier 14 is electrically connected to one end of the fourth 50-ohm impedance matching section 26. The other end of the fourth 50-ohm impedance matching section 26 is electrically connected to the DTV tuner module 15.

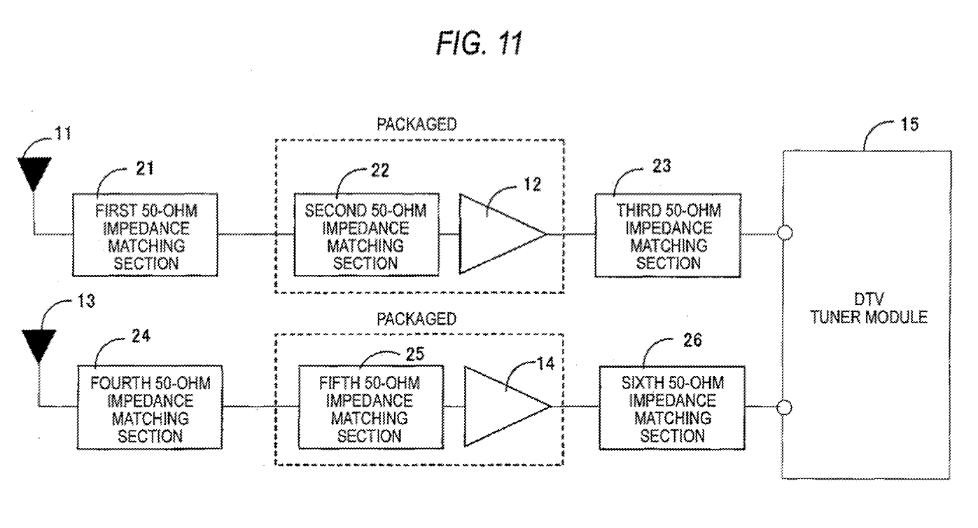

When compared with a related art configuration 2 shown in FIG. 11, the portable radio of the present embodiment does not have a fifth 50-ohm impedance matching section 25, and hence a loss attributable to the matching circuit is reduced. The sensitivity of the second antenna 13 is enhanced. Since the terminal impedances of the first and second amplifiers 12 and 14 differ from each other as in the case of the first embodiment shown in FIG. 1. Deterioration of electromagnetic field coupling is decreased.

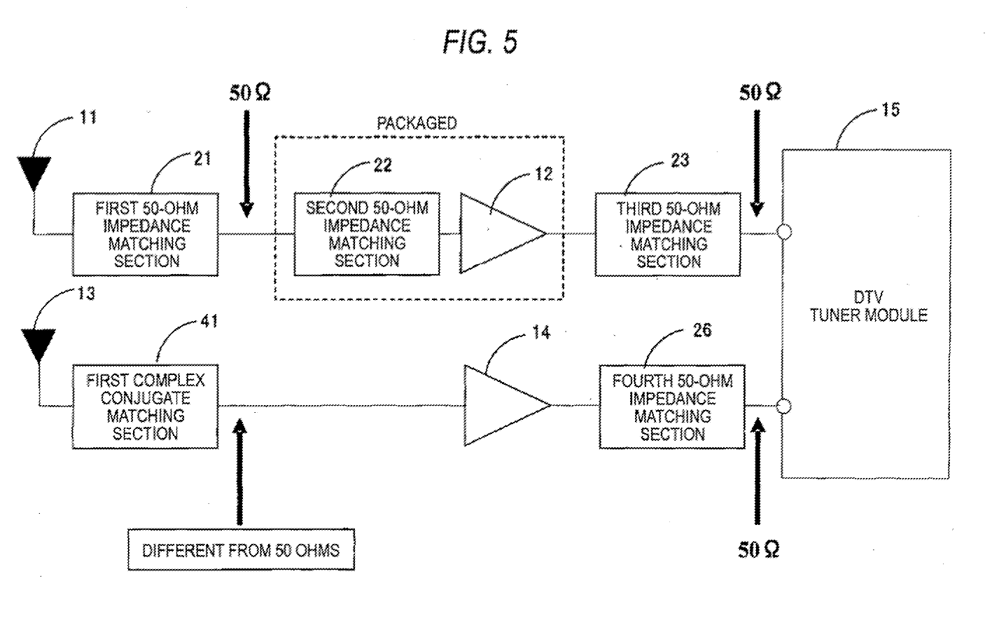

FIG. 5 is a view for explaining an impedance difference of circuitry in the portable radio of the present embodiment. As illustrated, in the portable radio of the present embodiment, an output terminal of the first 50-ohm impedance matching section 21, an output terminal of the third 50-ohm impedance matching section 23, and an output terminal of the fourth 50-ohm impedance matching section 26 assumes an impedance of 50 ohms. However, an output terminal of the complex conjugate matching section 41 does not assume an impedance of 50 ohms.

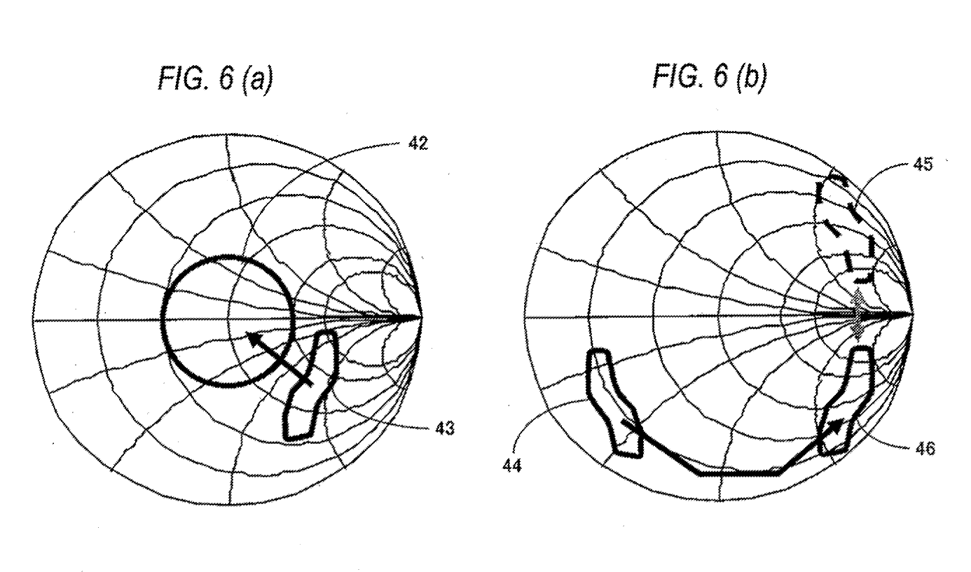

FIG. 6 shows a Smith chart for explaining a difference between the 50-ohm impedance matching section and the complex conjugate matching section in the portable radio of the present embodiment. FIG. 6(a) is a Smith chart showing operation of the 50-ohm impedance matching section; namely, operation for matching a certain impedance (falling in a domain designated by a solid line 43) to a value of 50-ohm designated by a solid line 42 or thereabouts. In general, the solid line 42 corresponds to a concentric circle in which a voltage standing wave ratio (VSWR) assumes a value of two or three and designates a domain in which an impedance is matched to about 50 ohms.

In FIG. 6(a), when the impedance falling within the domain encircled by the solid line 43 is comparatively close to 50 ohms, a matching circuit entailing a little loss can match the impedance to a value of 50 ohms or thereabouts designated by the solid line 42. In the meantime, when the impedance in the domain designated by the solid line 43 greatly differs from a value of 50 ohms, a matching circuit entailing a great loss is required.

For instance, in the portable radio shown in FIG. 5, the impedance of the first antenna 11 corresponds to the solid line 43, and the first 50-ohm impedance matching section 21 matches the impedance to an impedance designated by the solid line 42.

FIG. 6(b) shows a Smith chart showing operation of the complex conjugate matching section; namely, operation for matching a certain impedance (falling in a domain designated by a solid line 44) to an impedance designated by a solid line 46. The impedance designated by the solid line 46 is a complex conjugate impedance responsive to an impedance falling in the domain designated by a dotted line 45. Namely, complex conjugate impedances fall in domains that are linearly symmetrical about a resistance axis (X=0) on the Smith chart.

In this case, even if the impedance falling within the domain designated by the solid line 44 has greatly differed from a value of 50 ohms, it may be the case where even a matching circuit entailing a little loss can perform matching, so long as the impedance is changed to a complex conjugate impedance designated by the solid line 46 that is responsive to the impedance falling in the domain designated by the dotted line 45.

For instance, in the portable radio shown in FIG. 5, when the impedance of the second amplifier falls within the domain designated by the dotted line 45 and when the impedance of the second antenna 13 falls within the domain designated by the solid line 44, the complex conjugate matching section 41 matches the impedance of the second antenna 13 to an impedance falling within the domain designated by the solid line 46. A reactance component is thereby cancelled by a matched impedance and the impedance of the second amplifier. FIG. 5 is a view for the sake of explanation. In reality, a distance between the solid line 44 and the solid line 46 is shorter than an illustrated distance. The complex conjugate matching section 41 matches the impedance to a substantially complex conjugate impedance by means of at least one of the operating frequencies of the DTV. The word “complex conjugate impedance” employed herein means an impedance by means of which a complex conjugate relationship exists between two predetermined impedances.

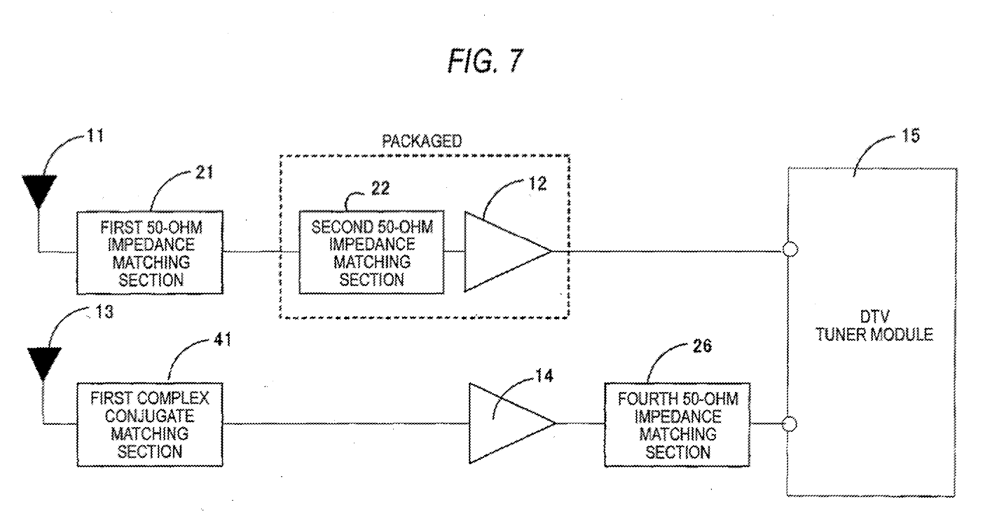

When a wire for electrically connecting the first amplifier 12 to the DTV tuner module 15 is shorter than a predetermined standard, the portable radio of the present embodiment does not need to be provided with the third 50-ohm impedance matching section 23, and the matching section can also be omitted. In this case, an output terminal of the first amplifier 12 is connected directly to an input terminal of the DTV tuner module 15. FIG. 7 shows a general configuration of the portable radio of the present embodiment achieved when the third 50-ohm impedance matching section 23 is omitted.

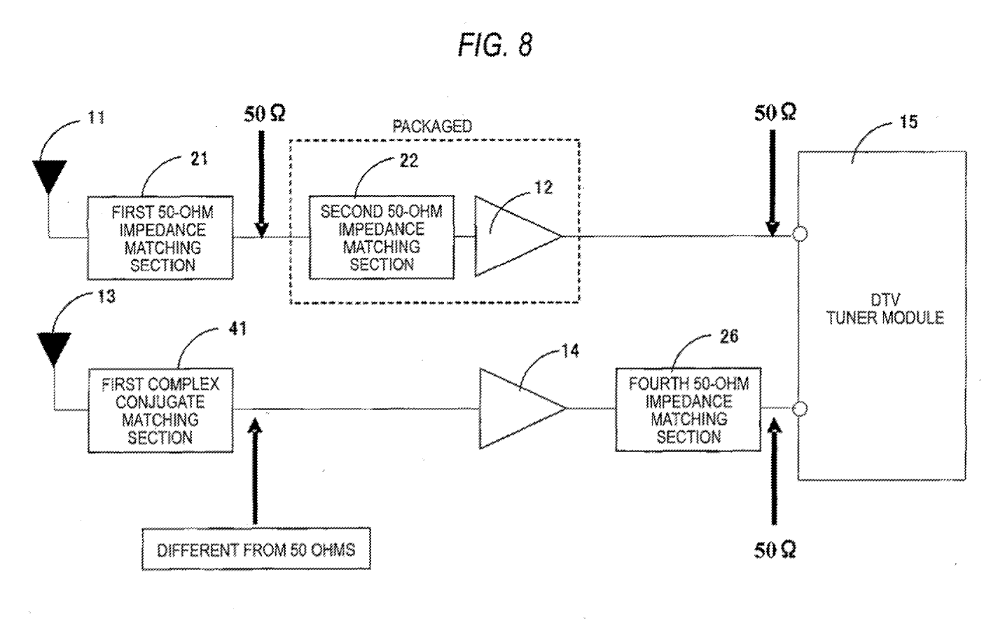

FIG. 8 shows an impedance difference of circuitry achieved when the third 50-ohm impedance matching section 23 is omitted from the portable radio of the present embodiment. As illustrated, the output terminal of the first 50-ohm impedance matching section 21, the output terminal (the input terminal of the DTV tuner module) of the first amplifier 12, and the output terminal of the fourth 50-ohm impedance matching section 26 assume an impedance of 50 ohms. However, the output terminal of the complex conjugate matching section 41 does not assume an impedance of 50 ohms.

Moreover, the portable radios shown in FIGS. 5 and 7 do not need the first 50-ohm impedance matching section 21, and the first 50-ohm impedance matching section can be omitted.

A type of the portable radio of the present embodiment is now described.

The impedance of the first antenna 11 and the impedance of the second antenna 13 are designed so as to become equal to a predetermined input impedance (e.g. 50 ohms) of the receiving circuit included in the DTV tuner module 15. For instance, in the case of an antenna that is used while projecting out of the portable radio, like a whip antenna, an input impedance of the antenna approximates to the predetermined input impedance. For this reason, in relation to a receiving line connected to the whip antenna (i.e., a line extending from the antenna to the DTV tuner module 15), a matching circuit entailing a little loss can be used even when an impedance matching section performs impedance matching at a stage immediately subsequent to the antenna.

As compared with the case of the whip antenna, when a built-in antenna element is used as an antenna, the input impedance of the antenna and the predetermined input impedance differ from each other by means of a loss, or the like, attributable to an enclosure of the portable radio itself. Therefore, in relation to the receiving line connected to the built-in antenna element, a matching circuit entailing a little loss can be used even when the complex conjugate matching section performs matching of a complex conjugate impedance at a stage immediately subsequent to the antenna.

Consequently, when the whip antenna and the built-in antenna element are used as antennas, the whip antenna is used as the first antenna 11, and the built-in antenna element is used as the second antenna 13. It is thereby possible to efficiently improve deterioration of an antenna gain and view a highly sensitive digital television broadcast.

When an enclosure dipole antenna that is a dipole antenna arranged in the enclosure of the portable radio is compared with the antenna element built in the enclosure of the portable radio, the enclosure dipole antenna is easy to gain an antenna gain. Therefore, when the enclosure dipole antenna and the built-in antenna element are used as antennas, the enclosure dipole antenna is used as the first antenna 11, and the built-in antenna element is used as the second antenna 13. It is thereby possible to efficiently improve deterioration of an antenna gain and view a highly sensitive digital television broadcast.

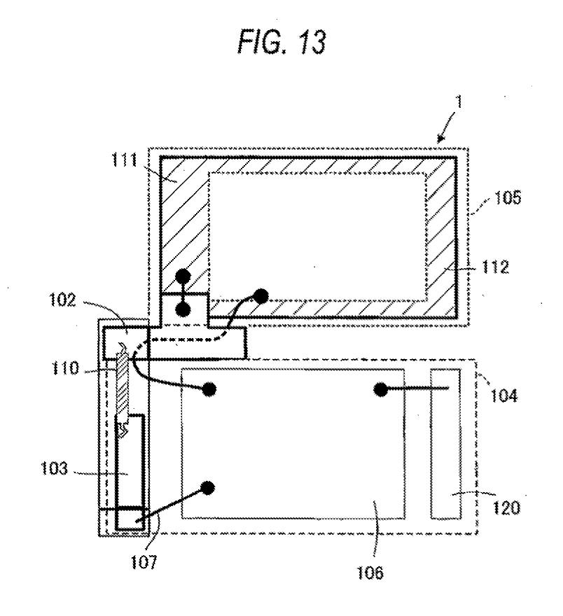

FIG. 13 is a view showing an example configuration of a portable radio having an enclosure dipole antenna and a built-in antenna element. In FIG. 13, the portable radio 1 has two enclosures; namely, an upper enclosure and a lower enclosure. The upper enclosure and the lower enclosure are reclosable in two directions; namely, a horizontal direction (a lateral direction) and a vertical direction (a longitudinal direction) by means of two hinges 102 and 103 made of a conductive member. The lower enclosure 104 is provided with a circuit board 106, and the upper enclosure 105 is provided with a circuit board 112. One end of an antenna element 110 provided on the lower enclosure 104 is connected to the hinge 103, and the other end of the antenna element 110 is connected to the hinge 102. The antenna element 110 is supplied with power from the circuit board 106 from a power feeding section 107 and the hinge 103. An antenna element 111 provided on the upper enclosure 105 is electrically connected to the hinge 102. The antenna element 111 is a metallic frame making up a portion of the upper enclosure 5. There is also a case where the circuit board 112 acts as the antenna element 111. There is built a dipole antenna in which the antenna elements 110, 111 and the hinges 102, 103 act as upper elements and in which a ground pattern of the circuit board 106 of the lower enclosure 104 acts as a lower element. The entirety of the enclosures is utilized as an antenna (an enclosure dipole antenna). As mentioned above, the enclosure dipole antenna is a dipole antenna including at least a portion of the circuit board 112 placed in the upper enclosure 105 and a portion of the circuit board 106 placed in the lower enclosure 104. Further, for instance, a built-in antenna element 120 that is placed in the lower enclosure 104 and that is supplied with electric power from the circuit board 106 is used as a built-in antenna element. The built-in antenna element is not limited solely to an interior of the lower enclosure 104 but may also be provided in the upper enclosure 105. A configuration shown in FIG. 13 is applicable to any of the first embodiment and the second embodiment.

The present invention is not limited to the embodiments and can be implemented in various forms without departing the scope of the gist of the invention.

For example, the present embodiments have provided the descriptions about the receiving function to be included by reference to a digital television broadcast. However, the present invention is not limited to the digital television broadcast. The present invention is applicable to a function that is implemented by means of receiving a radio wave by use of a plurality of antennas.

Although the present invention has been described in detail by reference to the specific embodiments, it is manifest to the persons who are skilled in the art that the present invention be susceptible to various alterations or modifications without departing the spirit and scope of the present invention.

The present patent application is based on Japanese Patent Application No. 2008-123155 filed on May 9, 2008, the entire subject matter of which is incorporated herein by reference.

### INDUSTRIAL APPLICABILITY

The present invention makes it possible to view a highly sensitive digital television broadcast by improving deterioration of an antenna gain attributable to electromagnetic field coupling between a plurality of antennas.

1. A portable radio comprising:
a first antenna;
a second antenna;
a first low noise amplifier whose one end is electrically connected to the first antenna;
a second low noise amplifier whose one end is electrically connected to the second antenna; and
a receiving circuit electrically connected to a remaining end of the first low noise amplifier and a remaining end of the second low noise amplifier, wherein
an input impedance of the first low noise amplifier and an input impedance of the second low noise amplifier entirely differ from each other in a predetermined operating frequency band of the receiving circuit.

2. A portable radio comprising:
a first antenna;
a first impedance matching section whose one end is electrically connected to the first antenna;
a first low noise amplifier whose one end is electrically connected to a remaining end of the first impedance matching section;
a second antenna;
a complex conjugate matching section whose one end is electrically connected to the second antenna;
a second low noise amplifier whose one end is electrically connected to a remaining end of the complex conjugate matching section;
a second impedance matching section whose one end is electrically connected to a remaining end of the second low noise amplifier; and
a receiving circuit electrically connected to a remaining end of the first low noise amplifier and a remaining end of the second impedance matching section, wherein
the first impedance matching section matches an input impedance of the first low noise amplifier to a predetermined input impedance of the receiving circuit;
the complex conjugate matching section matches an impedance of the second antenna and an impedance of an input stage of the second low noise amplifier to a complex conjugate impedance; and
the second impedance matching section matches an output impedance of the second low noise amplifier to a predetermined input impedance of the receiving circuit.

3. The portable radio according to claim 2, further comprising:
a third impedance matching section whose one end is electrically connected to the first antenna and whose remaining end is electrically connected to one end of the first impedance matching section, wherein the third impedance matching section matches the impedance of the first antenna to a predetermined input impedance of the receiving circuit.

4. The portable radio according to claim 3, further comprising a fourth impedance matching section whose one end is electrically connected to a remaining end of the first low noise amplifier and whose remaining end is electrically connected to the receiving circuit, wherein
the fourth impedance matching section matches an output impedance of the first low noise amplifier to a predetermined input impedance of the receiving circuit.

5. The portable radio according to claim 1, further comprising:
a diversity circuit for subjecting a signal from the first antenna and a signal from the second antenna to diversity processing,
wherein the diversity circuit is included in the receiving circuit or electrically connected to the receiving circuit.

6. The portable radio according to claim 5, wherein the diversity circuit is a diversity circuit for performing diversity combination processing.

7. The portable radio according to claim 2, wherein the first impedance matching section and the first low noise amplifier are built into a single module.

8. The portable radio according to claim 1, wherein the first antenna is a whip antenna projecting out of enclosures of the portable radio; and the second antenna is an antenna element built in the enclosures of the portable radio.

9. The portable radio according to claim 1, further comprising a first circuit board placed in a first enclosure and a second circuit board placed in a second enclosure, wherein the first antenna is a dipole antenna including at least a portion of the first circuit board and a portion of the second circuit board; and the second antenna is an antenna element built in the enclosures of the portable radio.

10. The portable radio according to claim 2, further comprising:
a diversity circuit for subjecting a signal from the first antenna and a signal from the second antenna to diversity processing,
wherein the diversity circuit is included in the receiving circuit or electrically connected to the receiving circuit.

11. The portable radio according to claim 6, wherein the diversity circuit is a diversity circuit for performing diversity combination processing.

12. The portable radio according to claim 2, wherein the first antenna is a whip antenna projecting out of enclosures of the portable radio; and the second antenna is an antenna element built in the enclosures of the portable radio.

13. The portable radio according to claim 2, further comprising a first circuit board placed in a first enclosure and a second circuit board placed in a second enclosure, wherein the first antenna is a dipole antenna including at least a portion of the first circuit board and a portion of the second circuit board; and the second antenna is an antenna element built in the enclosures of the portable radio.
